(19) United States
(12) Patent Application Publication
(10) Pub. No.: US 2019/0152241 A1
(43) Pub. Date: May 23, 2019

(54) PAPER TRAY DEVICE CAPABLE OF DETECTING AMOUNT OF PAPER AND METHOD OF DETECTING AMOUNT OF PAPER WITH PAPER TRAY DEVICE

(71) Applicant: AVISION INC., Hsinchu (TW)

(72) Inventors: Ming-Chung Li, Hsinchu County (TW); Yu-Lang Wang, Hsinchu County (TW); Kuang-Huan Li, Penghu County (TW); Xiang-Chi Lee, Taoyuan City (TW)

(21) Appl. No.: 16/143,499

(22) Filed: Sep. 27, 2018

(30) Foreign Application Priority Data
Nov. 17, 2017 (TW) 106139814

(51) Int. Cl. B41J 13/10; B65H 1/12; B65H 1/04; B65H 1/14

(52) U.S. Cl. CPC B41J 13/103; B65H 1/12; B65H 1/04; B65H 2801/03; B65H 2515/34; B65H 2511/214; B65H 1/14

(57) ABSTRACT

A paper tray includes a casing, a lifting mechanism, a weight detector, a storage unit, and a control unit. An accommodating space is formed inside the casing. The lifting mechanism is disposed inside the accommodating space for supporting and lifting at least one sheet of paper. The weight detector is disposed on the lifting mechanism for detecting a weight of the at least one sheet of paper. The storage unit is for storing paper information and a predetermined amount. The control unit is electrically connected to the weight detector and the storage unit. The control unit determines an amount of the at least one sheet of paper according to relation of the weight and the paper information and outputs a supplementary alert to an apparatus for reminding users when the control unit determines the amount of the at least one sheet of paper is less than the predetermined amount.

### BACKGROUND OF THE DISCLOSURE

### 1. Field of the Disclosure

The present disclosure relates to a paper tray device and a related method, and more particularly, to a paper tray device capable of detecting an amount of paper and a method of detecting the amount of the paper with the paper tray device.

### 2. Description of the Prior Art

In modern society, printing apparatuses with paper tray devices are widely used in offices for improving document processing quality and efficiency. However, situations of running out of paper often happen to the printing apparatus. Currently, there is a conventional paper tray device equipped with a transparent plastic component disposed on a casing, which allows a user to be aware of an amount of the paper therein by eye observation. However, such manual determining mechanism cannot provide an alert in advance for reminding the user of resupplying the paper in time to prevent the paper from running out. Furthermore, there is another conventional paper tray device capable of determining the amount of the paper by detecting a position of a lifting mechanism of the conventional paper tray device. However, such determining mechanism has low precision and cannot reflect the real-time amount of the paper, which fails to achieve an expected intelligent management effect.

### SUMMARY OF THE DISCLOSURE

Therefore, it is an objective of the present disclosure to provide a paper tray device capable of detecting an amount of paper and a method of detecting the amount of the paper with the paper tray device.

In order to achieve the aforementioned objective, the present disclosure discloses a paper tray device capable of detecting an amount of paper. The paper tray device includes a casing, a lifting mechanism, a weight detector, a storage unit and a control unit. An accommodating space is formed inside the casing. The lifting mechanism is disposed inside the accommodating space for supporting and lifting the paper. The weight detector is disposed on the lifting mechanism for detecting weight of the paper. The storage unit is for storing paper information and a predetermined amount. The control unit is electrically connected to the weight detector and the storage unit. The control unit determines the amount of the paper according to relation of the weight detected by the weight detector and the paper information stored in the storage unit and further outputs a supplementary alert to an apparatus when the control unit determines the amount of the paper is less than the predetermined amount.

According to an embodiment of the present disclosure, the paper tray device further includes an input unit for inputting the paper information or the predetermined amount into the storage unit.

According to an embodiment of the present disclosure, the paper information includes relation of a size or a thickness of the paper and a unit weight of the paper.

According to an embodiment of the present disclosure, the lifting mechanism includes a lifting plate and a lifting module. The lifting plate is for supporting the paper. The lifting module is for lifting the lifting plate.

According to an embodiment of the present disclosure, the weight detector is disposed on the lifting plate.

According to an embodiment of the present disclosure, the weight detector includes a weight detection component and an angle detection component. The weight detection component is for detecting an acting force of the paper upon the lifting plate and along a direction perpendicular to the lifting plate. The angle detection component is for detecting an inclined angle of the lifting plate relative to a horizontal direction.

According to an embodiment of the present disclosure, the apparatus is a printing apparatus or a remote monitoring apparatus.

According to an embodiment of the present disclosure, the predetermined amount is a minimum residual amount or a task required amount.

In order to achieve the aforementioned objective, the present disclosure further discloses a method of detecting an amount of paper with a paper tray device. The method includes a weight detector disposed on a lifting mechanism of the paper tray device detecting weight of the paper; a control unit of the paper tray device determining the amount of the paper according to relation of the weight detected by the weight detector and paper information stored in a storage unit of the paper tray device and further determining whether the amount of the paper is less than a predetermined amount; and the control unit outputting a supplementary alert to an apparatus when the control unit determines the amount of the paper is less than the predetermined amount.

According to an embodiment of the present disclosure, the method further includes utilizing an input unit of the paper tray device to input the paper information or the predetermined amount into the storage unit.

According to an embodiment of the present disclosure, the control unit of the paper tray device determining the amount of the paper according to the relation of the weight detected by the weight detector and the paper information stored in the storage unit of the paper tray device and further determining whether the amount of the paper is less than the predetermined amount includes the control unit of the paper tray device determining the amount of the paper according to the weight detected by the weight detector and relation of a size or a thickness of the paper and a unit weight of the paper and further determining whether the amount of the paper is less than the predetermined amount.

According to an embodiment of the present disclosure, the control unit outputting the supplementary alert to the apparatus when the control unit determines the amount of the paper is less than the predetermined amount includes the control unit outputting the supplementary alert to the apparatus when the control unit determines the amount of the paper is less than a minimum residual amount.

According to an embodiment of the present disclosure, the control unit outputting the supplementary alert to the apparatus when the control unit determines the amount of the paper is less than the predetermined amount includes the control unit outputting the supplementary alert to the apparatus when the control unit determines the amount of the paper is less than a task required amount.

According to an embodiment of the present disclosure, the control unit outputting the supplementary alert to the apparatus when the control unit determines the amount of the paper is less than the predetermined amount includes the control unit outputting the supplementary alert to a printing apparatus or a remote monitoring apparatus when the control unit determines the amount of the paper is less than the predetermined amount.

In summary, the present disclosure utilizes the weight detector to detect the weight of the paper and further utilizes the control unit to determine the amount of the paper according to the relation of the weight detected by the weight detector and the paper information stored in the storage unit, so as to instantly detect residual amount of the paper. Furthermore, when the control unit determines the amount of the paper is less than the predetermined amount, the control unit outputs the supplementary alert to the apparatus for reminding a user to resupply the paper in time before the paper runs out. Therefore, the present disclosure can achieve an intelligent management effect.

These and other objectives of the present disclosure will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a printing apparatus according to a first embodiment of the present disclosure.

FIG. 2 is a partial diagram of a paper tray device according to the first embodiment of the present disclosure.

FIG. 3 is a functional block diagram of the paper tray device according to the first embodiment of the present disclosure.

FIG. 4 is a flow chart diagram illustrating that the paper tray device executes a method of detecting an amount of paper therein according to the first embodiment of the present disclosure.

FIG. 5 is a functional block diagram of a paper tray device according to a second embodiment of the present disclosure.

FIG. 6 is a flow chart diagram illustrating that the paper tray device executes a method of detecting an amount of paper therein according to the second embodiment of the present disclosure.

FIG. 7 is another flow chart diagram illustrating that the paper tray device executes a method of detecting the amount of the paper therein according to the second embodiment of the present disclosure.

### DETAILED DESCRIPTION

In the following detailed description of the preferred embodiments, reference is made to the accompanying drawings which form a part hereof, and in which is shown by way of illustration specific embodiments in which the disclosure may be practiced. In this regard, directional terminology, such as “top,” “bottom,” “front,” “back,” etc., is used with reference to the orientation of the Figure(s) being described. The components of the present disclosure can be positioned in a number of different orientations. As such, the directional terminology is used for purposes of illustration and is in no way limiting. Accordingly, the drawings and descriptions will be regarded as illustrative in nature and not as restrictive.

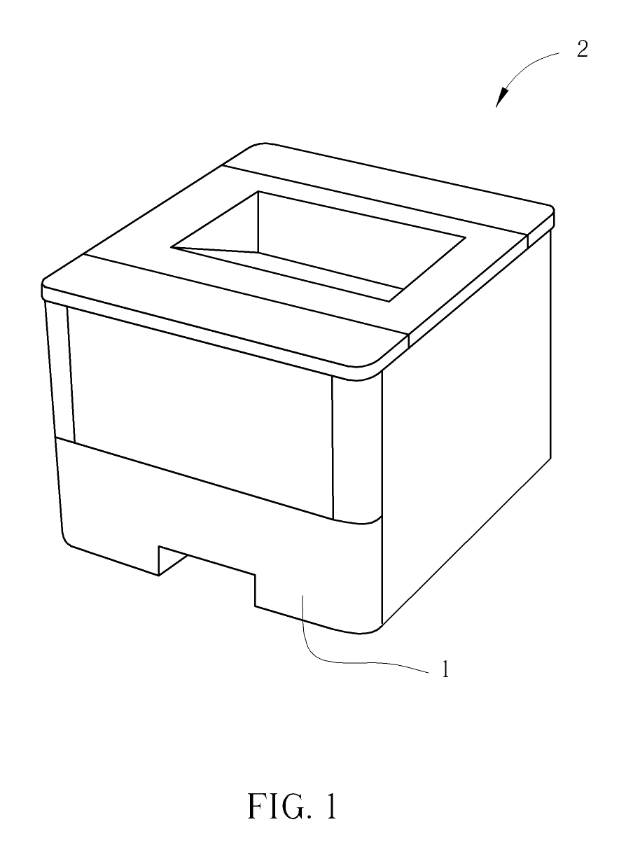

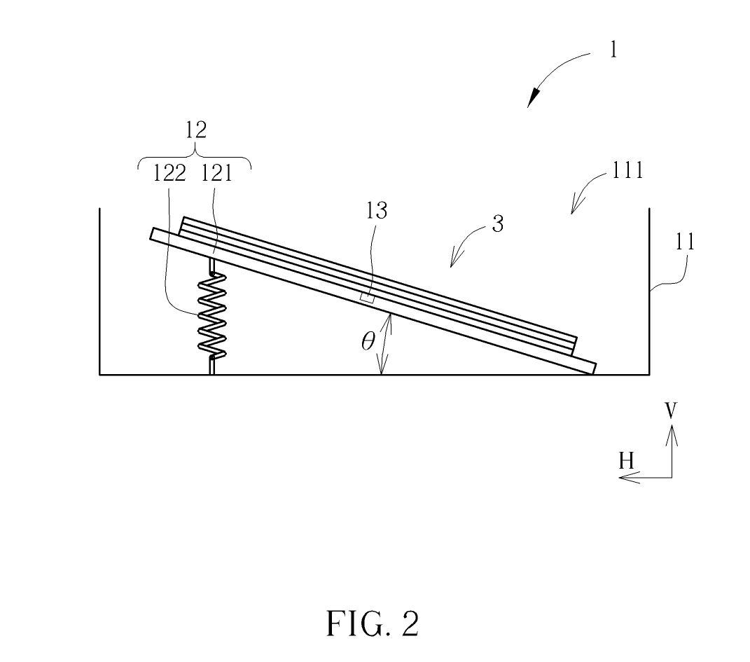

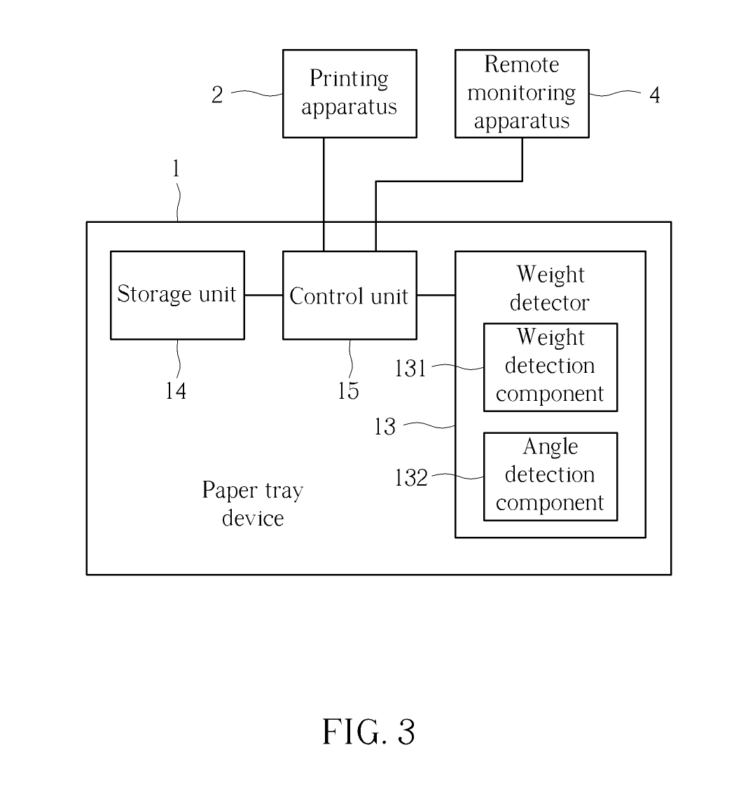

Please refer to FIG. 1 to FIG. 3. FIG. 1 is a schematic diagram of a printing apparatus 2 according to a first embodiment of the present disclosure. FIG. 2 is a partial diagram of a paper tray device 1 according to the first embodiment of the present disclosure. FIG. 3 is a functional block diagram of the paper tray device 1 according to the first embodiment of the present disclosure. As shown in FIG. 1 to FIG. 3, the paper tray device 1 is installed on the printing apparatus 2 and for receiving paper 3 required for printing. The paper tray device 1 includes a casing 11, a lifting mechanism 12, a weight detector 13, a storage unit 14 and a control unit 15. An accommodating space 111 is formed inside the casing 11. The lifting mechanism 12 is disposed inside the accommodating space 111 and for supporting and lifting the paper 3. The control unit 15 is electrically connected to the weight detector 13, the storage unit 14, the printing apparatus 2 and a remote monitoring apparatus 4, such as a computing apparatus. The weight detector 13 is disposed on the lifting mechanism 12 and for detecting weight of the paper 3. The storage unit 14 is for storing paper information and a predetermined amount. The control unit 15 determines an amount of the paper 3 according to relation of the weight detected by the weight detector 13 and the paper information stored in the storage unit 14 and further determines whether the amount of the paper 3 is less than the predetermined amount. Furthermore, the control unit 15 outputs a supplementary alert to the printing apparatus 2 or the remote monitoring apparatus 4 for reminding a user of resupplying the paper 3 when the control unit 15 determines the amount of the paper 3 is less than the predetermined amount. In this embodiment, the control unit 15 can be a microprocessor, a micro control unit (MCU), or a digital signal processor (DSP), and the storage unit 14 can be a non-transitory storage device, such as a hard disk drive, flash memory, and so on. However, it is not limited thereto.

As shown in FIG. 2, in this embodiment, the lifting mechanism 12 can include a lifting plate 121 and a lifting module 122. The lifting plate 121 is for supporting the paper 3. The lifting module 122 can include a resilient component 1221 for lifting the lifting plate 121. However, the lifting mechanism 12 of the present disclosure is not limited thereto. It depends on practical demands. For example, in another embodiment, the lifting module 122 also can include a driving motor and a cam mechanism. The driving motor can drive the cam mechanism to lift the lifting plate 121. Furthermore, as shown in FIG. 2 and FIG. 3, in this embodiment, while the lifting plate 121 is gradually lifted, an inclined angle θ of the lifting plate 121 relative to a horizontal direction H increases gradually. The weight detector 13 can include a weight detection component 131 and an angle detection component 132. The weight detection component 131 is for detecting an acting force applied by the paper 3 upon the lifting plate 121 and along a direction perpendicular to the lifting plate 121. The angle detection component 132 is for detecting the inclined angle of the lifting plate 121 relative to the horizontal direction H. In such a way, the weight detector 13 can obtain an acting force of the paper 3 along a vertical direction V perpendicular to the horizontal direction H, i.e., the weight of the paper 3.

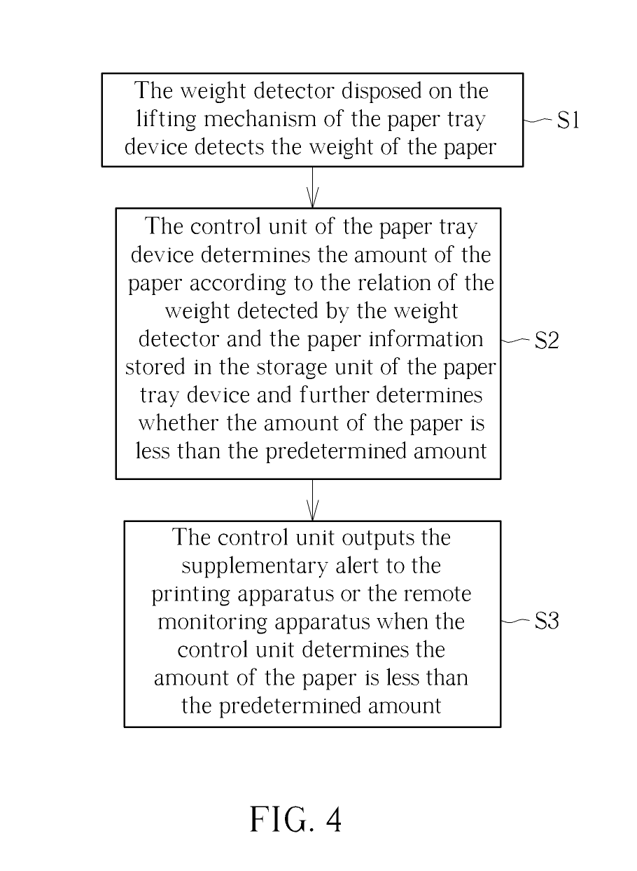

Please refer to FIG. 4. FIG. 4 is a flow chart diagram illustrating that the paper tray device 1 executes a method of detecting an amount of paper 3 therein according to the first embodiment of the present disclosure. As shown in FIG. 4, the method includes the following steps:

S1: The weight detector 13 disposed on the lifting mechanism 12 of the paper tray device 1 detects the weight of the paper 3;

S2: The control unit 15 of the paper tray device 1 determines the amount of the paper 3 according to the relation of the weight detected by the weight detector 13 and the paper information stored in the storage unit 14 of the paper tray device 1 and further determines whether the amount of the paper 3 is less than the predetermined amount; and

S3: The control unit 15 outputs the supplementary alert to the printing apparatus 2 or the remote monitoring apparatus 4 when the control unit determines the amount of the paper 3 is less than the predetermined amount.

More detailed description for the steps of the method is provided as follows. Firstly, the user can place the paper 3 on the lifting plate 121 of the lifting mechanism 12. At this moment, the weight detector 13 disposed on the lifting plate 121 detects the weight of the paper 3 (step S1). Afterwards, the paper 3 decreases gradually along with the printing process. The control unit 15 of the paper tray device 1 determines the amount of the paper 3 according to the relation of the weight detected by the weight detector 13 and the paper information stored in the storage unit 14 of the paper tray device 1 and further determines whether the amount of the paper 3 is less than the predetermined amount (step S2). For example, in this embodiment, the paper information can include a unit weight of the paper 3, and the predetermined amount can be a minimum residual amount. In other words, the control unit 15 can determine the amount of the paper 3 according to relation of the weight detected by the weight detector 13 and the unit weight of the paper 3, i.e., the amount of the paper 3 can be obtained by dividing the weight detected by the weight detector 13 by the unit weight of the paper 3. Furthermore, the control unit 15 can further determine whether the amount of the paper is less than the minimum residual amount. When the control unit 15 determines the amount of the paper 3 is less than the predetermined amount, i.e., the minimum residual amount, the control unit 15 outputs the supplementary alert to the printing apparatus 2 or the remote monitoring apparatus 4 for reminding the user of resupplying the paper 3 (step S3). The printing apparatus 2 or the remote monitoring apparatus 4 can remind the user by different ways, such as light, sound, or pop-up windows, after receiving the supplementary alert. For example, as for a printer or a multifunction apparatus for personal use or home use, the control unit 15 can output the supplementary alert to the printing apparatus 2 for reminding the user of resupplying the paper 3. As for a printer or a multifunction apparatus remotely managed by a webmaster, the control unit 15 can output the supplementary alert to the remote monitoring apparatus which is located away from the printing apparatus 2 for reminding the webmaster of resupplying the paper 3. In such a way, the webmaster can resupply the paper 3 in time before the paper 3 runs out, which solves the problem that the webmaster cannot resupply the paper 3 in time or has to check the printing apparatus 2 periodically.

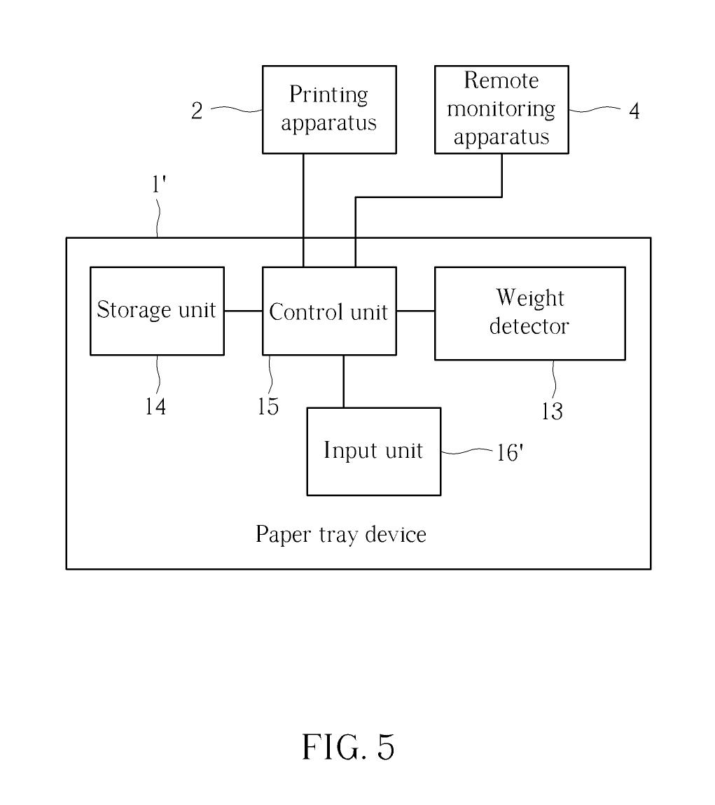

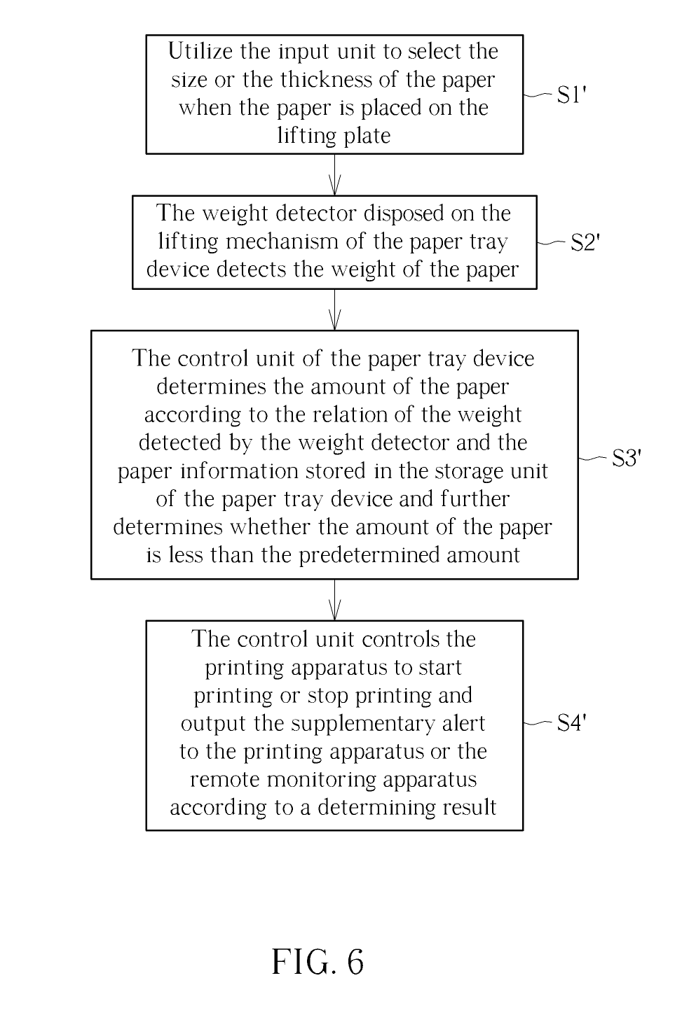

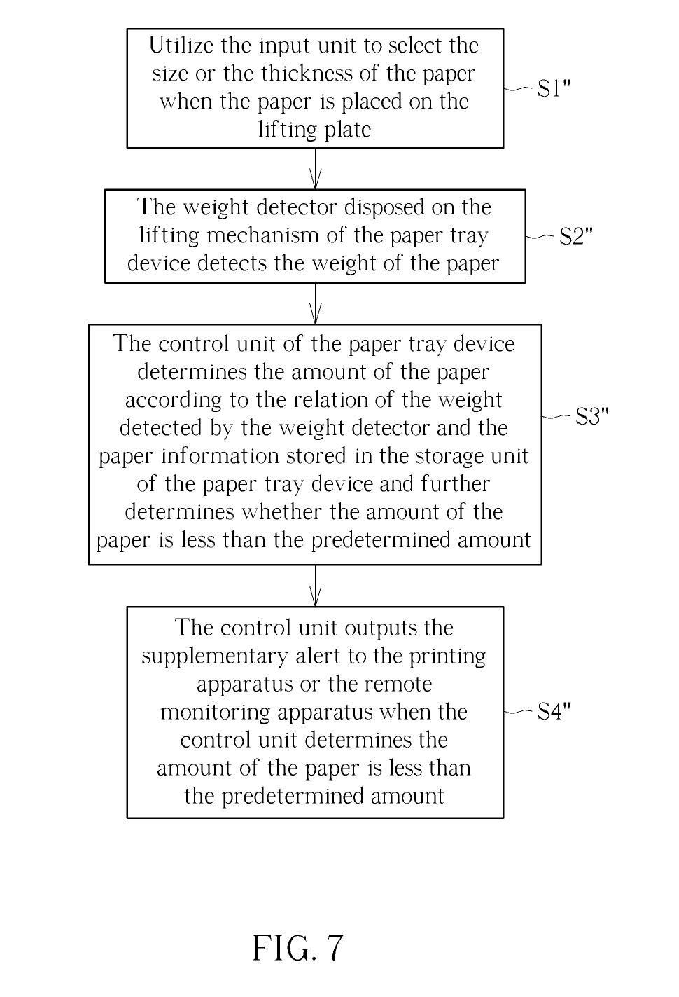

However, the present disclosure is not limited to the aforementioned embodiment. For example, please refer to FIG. 5 and FIG. 6. FIG. 5 is a functional block diagram of a paper tray device 1′ according to a second embodiment of the present disclosure. FIG. 6 is a flow chart diagram illustrating that the paper tray device 1′ executes a method of detecting the amount of paper 3 therein according to the second embodiment of the present disclosure. As shown in FIG. 5, different from the paper tray device 1 of the first embodiment, the paper tray device 1′ of the second embodiment further includes an input unit 16′ electrically connected to the control unit 15. The paper information stored in the storage unit 14 can include relation of sizes or thicknesses of the paper 3 and the unit weights of the paper 3 with different sizes or thicknesses. The predetermined amount stored in the storage unit 14 can be a task required amount, such as an amount of the paper required for printing a current printing task. As shown in FIG. 6, the input unit 16′ is used for providing an input interface, such as a touch input interface, for allowing the user to select the size or the thickness of the paper 3 after the paper 3 is placed on the lifting plate 121. In such a way, no matter the size or the thickness of the paper 3 is, the control unit 15 can accurately determine the amount of the paper 3 according to the weight detected by the weight detector 13 and relation of the size or the thickness of the paper 3 and the unit weight of the paper 3, i.e., the amount of the paper 3 can be obtained by dividing the weight detected by the weight detector 13 by the corresponding unit weight of the paper 3. When the control unit 15 determines the amount of the paper 3 is less than the task required amount, the control unit 15 controls the printing apparatus 2 to stop printing and output the supplementary alert to the apparatus for reminding the user of resupplying the paper 3. When the control unit 15 determines the amount of the paper 3 is greater than the task required amount, the control unit 15 controls the printing apparatus 2 to start printing (step S4′). Furthermore, please refer to FIG. 7. FIG. 7 is another flowchart diagram illustrating that the paper tray device 1′ executes a method of detecting the amount of the paper 3 therein according to the second embodiment of the present disclosure. As shown in FIG. 7, the input unit 16′ can be further be used for inputting the paper information or the predetermined amount into the storage unit 14 (step S1″). For example, when the paper 3 is placed on the lifting plate 121, the user can input the unit weight of the paper 3 or the minimum residual amount into the storage unit 14 by the input unit 16′, so as to achieve an effect of customization. When the control unit 15 determines the amount of the paper 3 is less than the minimum residual amount, the control unit 15 outputs the supplementary alert to the printing apparatus 2 or the remote monitoring apparatus 4 for reminding the user of resupplying the paper 3 (step S4″).

In contrast to the prior art, the present disclosure utilizes the weight detector to detect the weight of the paper and further utilizes the control unit to determine the amount of the paper according to the relation of the weight detected by the weight detector and the paper information stored in the storage unit, so as to instantly detect residual amount of the paper. Furthermore, when the control unit determines the amount of the paper is less than the predetermined amount, the control unit outputs the supplementary alert to the apparatus for reminding a user to resupply the paper in time before the paper runs out. Therefore, the present disclosure can achieve an intelligent management effect.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. A paper tray device capable of detecting an amount of paper, the paper tray device comprising:
a casing, an accommodating space being formed inside the casing;
a lifting mechanism disposed inside the accommodating space for supporting and lifting the paper;
a weight detector disposed on the lifting mechanism for detecting weight of the paper;
a storage unit for storing paper information and a predetermined amount; and
a control unit electrically connected to the weight detector and the storage unit, the control unit determining the amount of the paper according to relation of the weight detected by the weight detector and the paper information stored in the storage unit and further outputting a supplementary alert to an apparatus when the control unit determines the amount of the paper is less than the predetermined amount.

2. The paper tray device of claim 1, further comprising an input unit for inputting the paper information or the predetermined amount into the storage unit.

3. The paper tray device of claim 1, wherein the paper information comprises relation of a size or a thickness of the paper and a unit weight of the paper.

4. The paper tray device of claim 1, wherein the lifting mechanism comprises:
a lifting plate for supporting the paper; and
a lifting module for lifting the lifting plate.

5. The paper tray device of claim 4, wherein the weight detector is disposed on the lifting plate.

6. The paper tray device of claim 5, wherein the weight detector comprises:
a weight detection component for detecting an acting force of the paper upon the lifting plate and along a direction perpendicular to the lifting plate; and
an angle detection component for detecting an inclined angle of the lifting plate relative to a horizontal direction.

7. The paper tray device of claim 1, wherein the apparatus is a printing apparatus or a remote monitoring apparatus.

8. The paper tray device of claim 1, wherein the predetermined amount is a minimum residual amount or a task required amount.

9. A method of detecting an amount of paper with a paper tray device, the method comprising:
a weight detector disposed on a lifting mechanism of the paper tray device detecting weight of the paper;
a control unit of the paper tray device determining the amount of the paper according to relation of the weight detected by the weight detector and paper information stored in a storage unit of the paper tray device and further determining whether the amount of the paper is less than a predetermined amount; and
the control unit outputting a supplementary alert to an apparatus when the control unit determines the amount of the paper is less than the predetermined amount.

10. The method of claim 9, further comprising:
utilizing an input unit of the paper tray device to input the paper information or the predetermined amount into the storage unit.

11. The method of claim 9, wherein the control unit of the paper tray device determining the amount of the paper according to the relation of the weight detected by the weight detector and the paper information stored in the storage unit of the paper tray device and further determining whether the amount of the paper is less than the predetermined amount comprising:
the control unit of the paper tray device determining the amount of the paper according to the weight detected by the weight detector and relation of a size or a thickness of the paper and a unit weight of the paper and further determining whether the amount of the paper is less than the predetermined amount.

12. The method of claim 9, wherein the control unit outputting the supplementary alert to the apparatus when the control unit determines the amount of the paper is less than the predetermined amount comprising:
the control unit outputting the supplementary alert to the apparatus when the control unit determines the amount of the paper is less than a minimum residual amount.

13. The method of claim 9, wherein the control unit outputting the supplementary alert to the apparatus when the control unit determines the amount of the paper is less than the predetermined amount comprising:
the control unit outputting the supplementary alert to the apparatus when the control unit determines the amount of the paper is less than a task required amount.

14. The method of claim 9, wherein the control unit outputting the supplementary alert to the apparatus when the control unit determines the amount of the paper is less than the predetermined amount comprising:
the control unit outputting the supplementary alert to a printing apparatus or a remote monitoring apparatus when the control unit determines the amount of the paper is less than the predetermined amount.
